(19) United States
(12) Patent Application Publication
(10) Pub. No.: US 2025/0291676 A1
(43) Pub. Date: Sep. 18, 2025

(54) METHOD FOR REDUCING A TIME-TO-READY TIME IN CLIENT STORAGE DRIVES WITHOUT A CAPACITOR DURING UNGRACEFUL SHUTDOWN

(71) Applicant: SanDisk Technologies LLC, Austin, TX (US)

(72) Inventors: DHANUNJAYA RAO GORRLE, Fremont, CA (US); LEELADHAR AGARWAL, Fremont, CA (US)

(73) Assignee: SanDisk Technologies LLC, Austin, TX (US)

(21) Appl. No.: 18/603,159

(22) Filed: Mar. 12, 2024

(51) Int. Cl. G06F 11/14; G06F 9/4401

(52) U.S. Cl. CPC G06F 11/1417; G06F 9/4401

(57) ABSTRACT

A storage device may simplify an ungraceful shutdown recovery process and reduce a time-to-ready (TTR) value associated with an ungraceful shutdown bootup sequence. The storage device may include a cache to store data structures associated with host data and meta data. The storage device may also include a controller to store the data structures in a host memory buffer. After an ungraceful shutdown, the controller may execute a bootup sequence and access the host memory buffer during the bootup sequence. The controller may use the data structures stored in the host memory buffer to recover the host data and meta data. The controller applies the host data and meta data to the bootup sequence to simplify the ungraceful shutdown recovery process and reduce the TTR value associated with the ungraceful shutdown bootup sequence.

### BACKGROUND

A storage device, for example, a Solid-State Drive (SSD), may be communicatively coupled to a host and to non-volatile memory including, for example, a NAND flash memory device on which the storage device may store data received from the host. The host and storage device may communicate via a Non-Volatile Memory Express (NVMe) communication protocol using a peripheral component interconnect express (PCI Express or PCIe) interface. The memory device may include multiple dies which may be divided into physical blocks that may be grouped together into a plane. A memory die may include a single plane full of data blocks or multiple planes that have been linked together. Physical blocks from multiple dies may also be configured to form a super block. i.e., a logical block which may be composed of physical blocks from all the dies and channels in the memory device to extract higher throughput for parallel reads and writes.

When the host sends data to the storage device to be stored on the memory device, the storage device may run in a write-back/cache mode for higher write performance, wherein a controller on the storage device may send a completion notification to the host for a write command received from the host as soon as the corresponding data is transferred to a cache in the storage device. The controller may commit the data to persistent media (for example, NAND) at a later point in time. However, before the controller commits the data to the persistent media, the storage device may experience an improper shutdown or sudden power loss (also referred to herein as an ungraceful shutdown) or the controller may perform a PCIe reset on the storage device.

Some storage devices may include capacitors and the controller in these devices may handle an ungraceful shutdown or a PCIe reset using a Power Loss Protection (PLP) mechanism. With the PLP mechanism, the capacitor may supply power for a limited time for the controller to save critical information such as the host data in the cache memory, metadata, etc. and for the controller to recover the storage device with the saved critical data during a reboot. This may result in a low time-to-ready (TTR) value, i.e., a value reflective of the time between when the storage device is powered on and when it is ready to communicate with the host.

Storage devices that are designed and developed for client environments (referred to herein as client storage devices) such as laptops, tablets, gaming consoles, etc. may not have capacitors for cost reasons. When an ungraceful shutdown or PCIe reset occurs in client storage devices, the controller may not have sufficient time to save the last good written pointers for all open blocks which were involved in program operations at or around the ungraceful shutdown timeframe and the controller may not be able to save the host data stored in the cache. The controller also may be unable to save the metadata and/or data structures needed for a smooth and faster initialization of the host data when the storage device is later powered on.

To prevent user data and/or metadata loss after an ungraceful shutdown or PCIe reset on a client storage device, for the ungraceful shutdown bootup sequence, the controller may execute recovery algorithms such as binary search algorithms to find the last written word line in a NAND block. The recovery algorithms may also include a divide and conquer algorithm to collect the last written good pointers from the plane-level, physical block-level, and aggregated at a super-block level to arrive at the super-block level next-to-write word line pointer. The next-to-write word line pointer should neither cause an overwrite of any previously written word line nor result in a gap in the program sequence in a NAND block. Once the last good written pointers in the open super blocks are identified, the controller may try to recover and rebuild logical-to-physical (L2P) mapping entries which were not synced during the ungraceful power down.

In cases where a logical block address (LBA) is being written multiple times within the open super block(s), the controller may use a sequence number order to account for multiple host writes for the same LBA. The controller may also resolve conflicts of having the same LBA recovered from a current relocation open block and host blocks. Furthermore, the controller may rebuild a flash translation layer metadata for all open super blocks and ensure that the data integrity for each respective open block has been established before the storage device is set for host read and write commands. The recovery algorithms in client storage devices are therefore time-intensive, computationally intensive, and complex and may take several seconds to complete which may result in a typically higher TTR value as compared to the TTR value of a graceful shutdown wherein host and metadata were properly saved prior to shutting down the storage device.

### SUMMARY

In some implementations, the storage device may simplify an ungraceful shutdown recovery process and reduce a time-to-ready (TTR) value associated with an ungraceful shutdown bootup sequence. The storage device may include a cache to store data structures associated with host data and meta data. The storage device may also include a controller to store the data structures in a host memory buffer. After an ungraceful shutdown, the controller may execute a bootup sequence and access the host memory buffer during the bootup sequence. The controller may use the data structures stored in the host memory buffer to recover the host data and meta data. The controller applies the host data and meta data to the bootup sequence to simplify the ungraceful shutdown recovery process and reduce the TTR value associated with the ungraceful shutdown bootup sequence.

In some implementations, a storage device may simplify an ungraceful shutdown recovery process and reduce the TTR value associated with an ungraceful shutdown bootup sequence. The controller may store the data structures in the host memory buffer and store a memory address for the host memory buffer in a base address register After an ungraceful shutdown, the controller may execute a bootup sequence and use the memory address to access the host memory buffer during configuration of the storage device. The controller may apply the host data and meta data stored in the host memory buffer to the bootup sequence to simplify the ungraceful shutdown recovery process and reduce the TTR value associated with the ungraceful shutdown bootup sequence.

In some implementations, a method is provided for simplifying an ungraceful shutdown recovery process and reducing a TTR value associated with an ungraceful shutdown bootup sequence in a storage device. The method includes storing data structures to recover host data and meta data after an ungraceful shutdown in a cache in the storage device and in a host memory buffer. The method also includes executing a bootup sequence after the ungraceful shutdown and accessing the host memory buffer during the bootup sequence. The method further includes using the data structures stored in the host memory buffer to recover the host data and meta data stored in the host memory buffer prior to the ungraceful shutdown. The method also includes applying the host data and meta data to the bootup sequence to simplify the ungraceful shutdown recovery process and reduce the TTR value associated with the ungraceful shutdown bootup sequence.

### BRIEF DESCRIPTION OF THE SEVERAL VIEWS OF THE DRAWINGS

FIG. 1 is a schematic block diagram of an example system in accordance with some implementations.

FIG. 2 is a block diagram showing recovery information on a host memory buffer and a cache on a client storage device in accordance with some embodiments.

FIG. 3 is a block diagram of a peripheral component interconnect express (PCI Express or PCIe) configuration access mechanism address space for enabling a controller in a client storage device to access a host memory buffer before an interface is established between the host and the storage device in accordance with some implementations.

FIG. 4 is an example of a flow diagram for performing recovery in a client storage device after an ungraceful shutdown in accordance with some implementations.

FIG. 5 is a diagram of an example environment in which systems and/or methods described herein are implemented.

FIG. 6 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

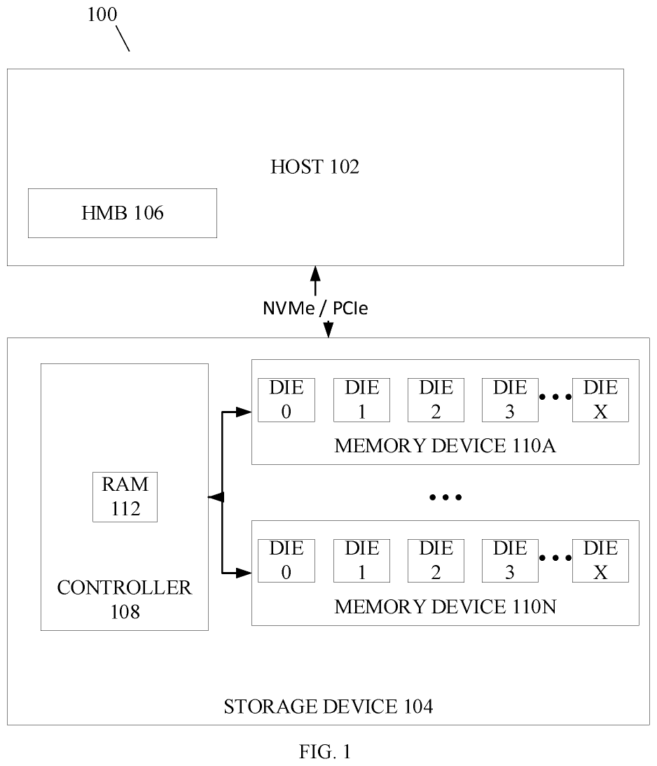

FIG. 1 is a schematic block diagram of an example system in accordance with some implementations. System 100 includes a host 102 and a storage device 104, that may communicate via Non-Volatile Memory Express (NVMe) over peripheral component interconnect express (PCI Express or PCIe) standard. Host 102 may transmit commands to read data or write data to storage device 104. Host 102 may include a host memory buffer (HMB) 106 that storage device 104 may use to cache data when processing the host commands. Host 102 and storage device 104 may be in the same physical location as components on a single computing device or on different computing devices that are communicatively coupled. Storage device 104, in various implementations, may be disposed in one or more different locations relative to the host 102. Host 102 may include additional components (not shown in this figure for the sake of simplicity).

Storage device 104 may include a controller 108, one or more non-volatile memory devices 110a-110c (referred to herein as the memory device(s) 110), and a random-access memory (RAM) 112. Storage device 104 may be, for example, a solid-state drive (SSD), and the like. Memory device 110 may be flash based. For example, memory device 110 may be a NAND flash memory that may be used for storing host and control data over the operational life of memory device 110. Memory device 110 may include multiple dies (shown as Die 0-Die X). Die 0-Die X may be divided into blocks. A super block (i.e., a logical block) may be formed in an interleaved manner where the super block may include a physical block from all the dies and channels in memory device 110. Memory device 110 may be included in storage device 104 or may be otherwise communicatively coupled to storage device 104.

Data may be stored in the blocks on memory device 110 in various formats, with the formats being defined by the number of bits that may be stored per memory cell. For example, a single-layer cell (SLC) format may write one bit of information per memory cell, a multi-layer cell (MLC) format may write two bits of information per memory cell, a triple-layer cell (TLC) format may write three bits of information per memory cell, and a quadruple-layer cell (QLC) format may write four bits of information per memory cell, and so on. Formats storing fewer bits in each cell are more easily accessed, durable, and less error-prone than formats storing more bits per cell. However, formats storing fewer bits in each cell are also more expensive.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh and/or relocate the data on memory device 110.

When storage device 104 is a client storage device, the size of RAM 112 may be limited and as such, controller 108 may use HMB 106 to improve the performance of storage device 104. Controller 108 may have discretion on how it will use HMB 106. However, the size of RAM 112 may drive how much information controller 108 may save on HMB 106. In some implementations, most of HMB 106 may be used for a Flash Transition Layer (FTL) logical to physical (L2P) mappings as this may help controller 108 to saturate the PCIe/host interface in terms of the throughput in random workloads. A smaller portion of HMB 106 may be used for metadata including, for example, RAID parity data for current open super blocks.

Controller 108 may also use HMB 106 to save critical data structures and thereby improve a time-to-ready (TTR) value and reduce the efforts to recover host data and metadata after an ungraceful shutdown. If storage device 104 goes through an ungraceful shutdown while HMB 106 is available to controller 108, controller 108 may leverage HMB 106 for critical information that a bootup firmware sequence may require when storage device 104 is powered on. A major complexity in an ungraceful shutdown firmware bootup sequence lies in identifying the last good written pointers for all open blocks which were involved in program operations at or around the ungraceful shutdown timeframe as the information for the pointers may not have been saved in memory device 110.

In an implementation, controller 108 may simplify this bootup sequence by saving critical FTL information like the last written pointers for all open blocks and/or next-to-write pointers for all open blocks to HMB 106 and/or RAM 112. The information stored in HMB 106 and/or RAM 112 may logical-to-physical mapping information and pointers that have not been written in persistent memory device 110. Controller 108 may save this critical information whenever a word line is attempted to be written to NAND. For example, if controller 108 writes to word line one, controller may save the pointer to word line one in RAM 112 and HMB 106. This data structure may typically be in the order of Kilobytes (K) and may be a function of (i.e., dependent on) the number of open blocks. For example, if there is one open block, controller 108 may save one pointer in HMB 106 and RAM 112, if there are two open blocks, controller 108 may save two pointers in HMB 106 and RAM 112, and so on.

Controller 108 may also save other critical information such as an in-memory data structure update to rebuild L2P mappings in HMB 106 and/or RAM 112. For example, controller 108 may save, in HMB 106 and/or RAM 112, logical block address (LBA) information including a Namespace ID plus the LBA within the namespace for open blocks. This may typically take about 32K per die block in TLC mode in the current Bit Cost Scalable (BiCS) generation and 128K for a superblock formed from four die blocks. For four open TLC blocks, the data structure for saving the host LBA plus namespace ID may be around 512K. To address issues relating to the space needed to save the host LBA plus namespace ID for the entire/all open blocks, controller 108 may optionally save the host LBA plus namespace ID for a predefined number of super-word lines instead of all open blocks. For example, controller 108 may save the host LBA plus namespace ID for three-word lines (for example, word line (n−2), word line (n−1) and word line (n)) along with the last written word line pointers to account for the fact that metadata saved in HMB 106 is also saved the RAM 112.

To ensure that the critical information saved in HMB 106 is available for faster bootup sequence after an ungraceful shutdown, controller 108 may have to ensure the availability of HMB 106 when considering other TTR requirements. For instance, to access the information stored in HMB 106 during an early ungraceful shutdown bootup stage, i.e., a stage before controller 108 establishes an interface with host 102 and enables NVMe commands, controller 108 may use one or more unused base address registers (referred to herein BAR registers) in PCIe. Each BAR register is a register in a PCI configuration access mechanism address space that may function as a memory pointer, wherein the memory address a BAR register points to may be accessed by controller 108 during configuration of storage device 104 after an ungraceful shutdown.

The PCI configuration access mechanism address space typically includes four to six BAR registers (for example, BAR0-BAR5). Client storage devices 104 may typically use BAR0, and seldom BAR1. Controller 108 may store HMB 106 memory address in one or more BAR registers (for example, one or more of BAR1-BAR5). HMB 106 information stored in one or more BAR registers may include a unique signature as a header and/or footer to enable controller 108 to validate the content during the ungraceful shutdown recovery. Controller 108 may use the unique signature to validate the HMB information accessed through a BAR register and then controller 108 may apply the BAR register content (i.e. HMB memory location) in a boot-up sequence. After validating the HMB information during the ungraceful shutdown recovery and reading the HMB address from one or more BAR registers, controller 108 may fetch the content stored in HMB 106 including, the last good written pointers, the recently written host LBAs, and other information needed to complete the boot-up sequence using PCIe transaction layer packets (TLPs). Controller 108 may apply sanity checks like the unique signature at the header and/or footer, cyclic redundancy checks, etc., and validate the information by optionally performing a few reads from memory device 110. By leveraging HMB 106 and the BAR registers to access the metadata information needed for completing a bootup sequence, the ungraceful shutdown bootup sequence may be simplified to correspond with a graceful shutdown bootup sequence, thus reducing the TTR value associated with an ungraceful shutdown bootup sequence.

In cases where controller 108 cannot access HMB 106 and/or the BAR registers including pointers to HMB 106 to retrieve the metadata information needed for completing an ungraceful shutdown bootup sequence, controller 108 may prevent user data and/or metadata loss after an ungraceful shutdown or PCIe reset on client storage device 104, by executing recovery algorithms such as binary search algorithms to find the last written word line in a NAND block. Controller 108 may also execute a divide and conquer algorithm to collect the last written good pointers from the plane-level, physical block-level, and aggregated at a super-block level to arrive at the super-block level next-to-write word line pointer. Once the last good written pointers in the open super blocks are identified, the controller may try to recover and rebuild logical-to-physical (L2P) mapping entries which could not be synced during the ungraceful power down.

Storage device 104 may perform these processes based on a processor, for example, controller 108 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

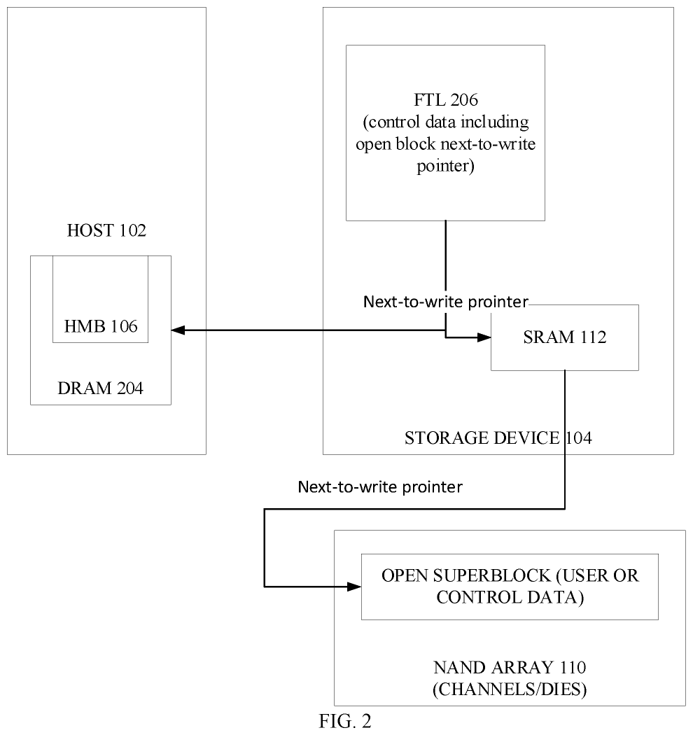

FIG. 2 is a block diagram showing recovery information on a host memory buffer and a cache on a client storage device in accordance with some embodiments. Host 102 may include a dynamic random-access memory (DRAM) 204, part of which may be used as HMB 106 to save critical data structures and thereby improve the TTR value associated with recovery from an ungraceful shutdown. Storage device 104 may include a static random-access memory (SRAM) 112 and a flash translation layer (FTL) 206. FTL 206 may map host side logical block addresses to the physical addresses of memory device 110. FTL 206 may generate or obtain control data including an open block next-to-write pointer for open blocks on memory device 110. The next-to-write pointer may be associated with an open super block including user data or control data, Controller 108 may initially cache the open block next-to-write pointer in HMB 106 and SRAM 112 and may later store the next-to-write pointer in memory device 110. As indicated above FIG. 2 is provided as an example. Other examples may differ from what is described in FIG. 2.

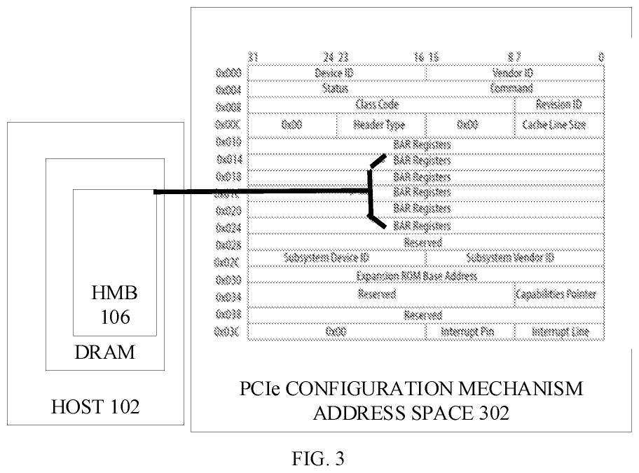

FIG. 3 is a block diagram of a PCI configuration access mechanism address space for enabling a controller in a client storage device to access a host memory buffer before an interface is established between the host and the storage device in accordance with some implementations. When storage device 104 is powered on after an ungraceful shutdown, before controller 108 establishes an interface with host 102 and enables NVMe commands, controller 108 may access one or more of the unused BAR registers in PCI configuration access mechanism address space 302. One or more of BAR registers may point to memory address of HMB 106. For example, controller 108 may access one or more of BAR1-BAR5 to obtain the memory address for HMB 106. After accessing the memory address of HMB 106 via the pointer stored in one or more BAR registers, controller 108 may validate the HMB information using a unique signature stored with the memory address of HMB 106. Once the HMB information has been validated, controller 108 may read the address from one or more BAR registers and fetch the content stored in HMB 106 including, the last good written pointers, the recently written host LBAs, and other information to complete the boot-up sequence using PCIe transaction layer packets. As indicated above FIG. 3 is provided as an example. Other examples may differ from what is described in FIG. 3.

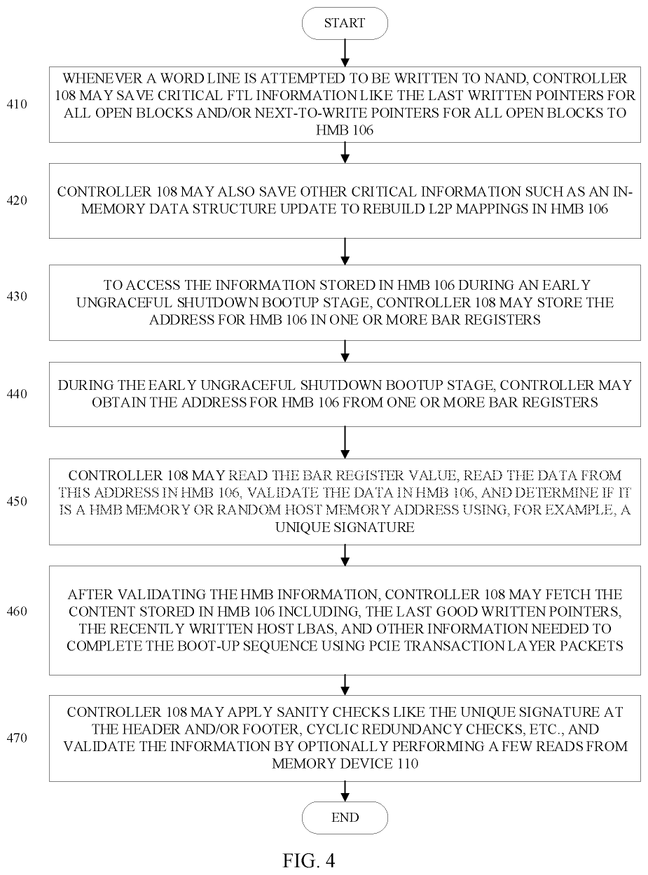

FIG. 4 is an example of a flow diagram for performing recovery in a client storage device after an ungraceful shutdown in accordance with some implementations. At 410, whenever a word line is attempted to be written to NAND, controller 108 may save critical FTL information like the last written pointers for all open blocks and/or next-to-write pointers for all open blocks to HMB 106. At 420, controller 108 may also save other critical information such as an in-memory data structure update to rebuild L2P mappings in HMB 106. At 430, to access the information stored in HMB 106 during an early ungraceful shutdown bootup stage, controller 108 may store the address for HMB 106 in one or more BAR registers. At 440, during the early ungraceful shutdown bootup stage, controller may obtain the address for HMB 106 from one or more BAR registers.

At 450, controller 108 may read BAR register value, read the data from this address in HMB 106, validate the data in HMB 106, and determine if it is a HMB memory or random host memory address using, for example, a unique signature. At 460, after validating the HMB information, controller 108 may fetch the content stored in HMB 106 including, the last good written pointers, the recently written host LBAs, and other information needed to complete the boot-up sequence using PCIe transaction layer packets. At 470, controller 108 may apply sanity checks like the unique signature at the header and/or footer, cyclic redundancy checks, etc., and validate the information by optionally performing a few reads from memory device 110. As indicated above FIG. 4 is provided as an example. Other examples may differ from what is described in FIG. 4.

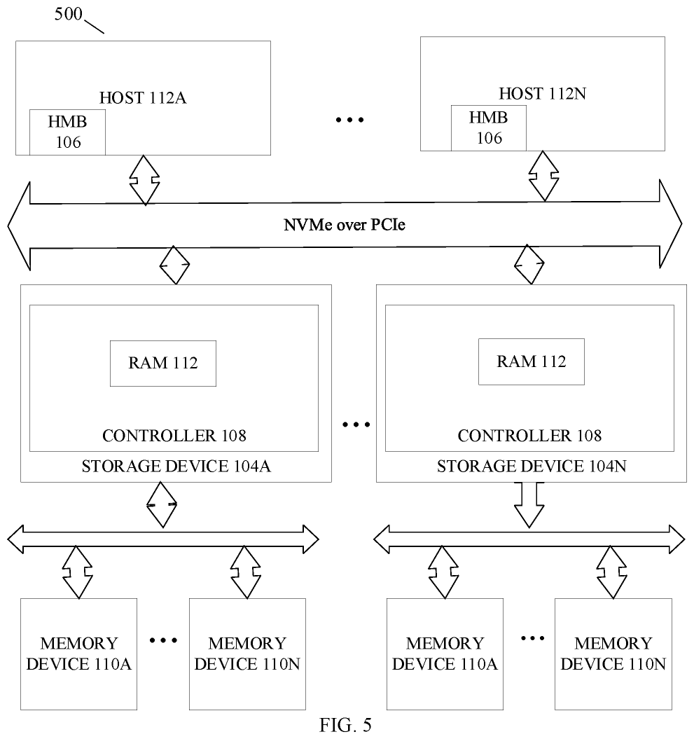

FIG. 5 is a diagram of an example environment in which systems and/or methods described herein are implemented. As shown in FIG. 5, Environment 500 may include hosts 102-102n (referred to herein as host(s) 102), and one or more client storage devices 104a-104n (referred to herein as storage device(s) 104). Storage device 104 may include a controller 108 to access information in a HMB 106 in host 102 and use the information during recovery after an ungraceful shutdown to reduce the TTR value associated with the recovery. Hosts 102 and storage devices 104 may communicate via Non-Volatile Memory Express (NVMe) over peripheral component interconnect express (PCI Express or PCIe), or the like.

Devices of Environment 500 may interconnect via wired connections, wireless connections, or a combination of wired and wireless connections. For example, the network in FIG. 5 may include NVMe over Fabric (NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of Environment 500 may perform one or more functions described as being performed by another set of devices of Environment 500.

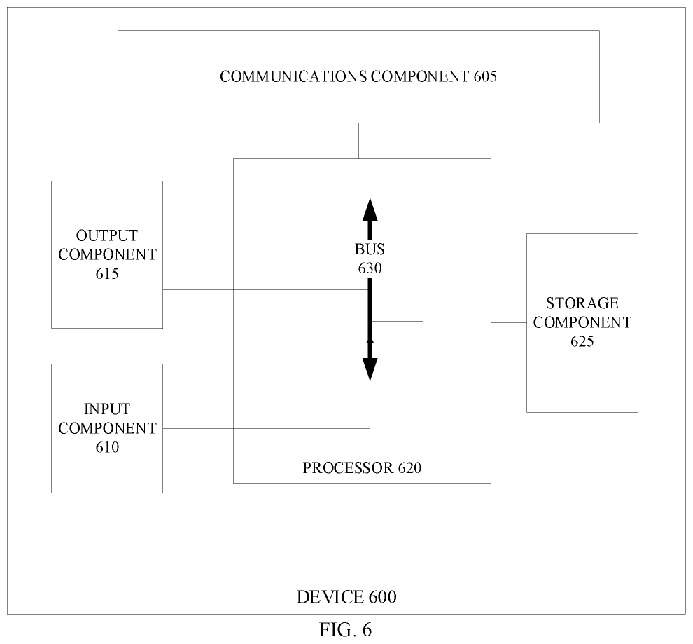

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, and a network/data connection port, or the like), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and network/data connection port, or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory (RAM) 112, read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to simplify an ungraceful shutdown recovery process and reduce a time-to-ready (TTR) value associated with an ungraceful shutdown bootup sequence, the storage device comprises:
a cache to store data structures associated with host data and meta data; and
a controller to store the data structures in a host memory buffer, execute a bootup sequence after an ungraceful shutdown, access the host memory buffer during the bootup sequence and use the data structures stored in the host memory buffer to recover the host data and meta data, and apply the host data and meta data to the bootup sequence to simplify the ungraceful shutdown recovery process and reduce the TTR value associated with the ungraceful shutdown bootup sequence.

2. The storage device of claim 1, wherein the data structures include last good written pointers for open blocks which were involved in program operations at an ungraceful shutdown timeframe, wherein information for the last good written pointers have not been saved in a memory device.

3. The storage device of claim 1, wherein the data structures include a next-to-write pointer for an open super block, wherein the next-to-write pointer has not been saved in a memory device.

4. The storage device of claim 1, wherein the data structures include an in-memory data structure update to rebuild logical-to-physical mappings in the host memory buffer.

5. The storage device of claim 4, wherein the in-memory data structure update includes logical block address information including a namespace identifier plus a logical block address within a namespace for open blocks in a memory device.

6. The storage device of claim 4, wherein the in-memory data structure update is associated with open blocks in a memory device.

7. The storage device of claim 4, wherein the in-memory data structure update is associated with a predefined number of super word lines in a memory device.

8. The storage device of claim 1, wherein the data structure is stored on the host memory buffer when a word line is to be written to a memory device.

9. The storage device of claim 1, wherein a size of the data structure stored on the host memory buffer is dependent on a number of open blocks.

10. The storage device of claim 1, wherein the controller stores a memory address for the host memory buffer in a base address register and uses the memory address to access the host memory buffer during configuration of the storage device after the ungraceful shutdown.

11. The storage device of claim 10, wherein during the ungraceful shutdown recovery process, the controller reads the base address register value, reads data from the base address register in the host memory buffer, validates the data in the host memory buffer using a signature, and fetches content stored in the host memory buffer to complete the boot-up sequence.

12. The storage device of claim 10, wherein the controller applies a host memory buffer location in the bootup sequence after validating the base address register that includes the memory address for the host memory buffer.

13. A storage device to simplify an ungraceful shutdown recovery process and reduce a time-to-ready (TTR) value associated with an ungraceful shutdown bootup sequence, the storage device comprises:
a cache to store data structures associated with host data and meta data; and
a controller to store the data structures in a host memory buffer and to store a memory address for the host memory buffer in a base address register, execute a bootup sequence after an ungraceful shutdown, use the memory address to access the host memory buffer during configuration of the storage device after the ungraceful shutdown, and apply the host data and meta data stored in the host memory buffer to the bootup sequence to simplify the ungraceful shutdown recovery process and reduce the TTR value associated with the ungraceful shutdown bootup sequence.

14. The storage device of claim 13, wherein during the ungraceful shutdown recovery process, the controller reads the base address register value, reads data from the base address register in the host memory buffer, validates the data in the host memory buffer using a signature, and fetches content stored in the host memory buffer to complete the boot-up sequence.

15. The storage device of claim 13, wherein the controller applies a host memory buffer location in the bootup sequence after validating the base address register that includes the memory address for the host memory buffer.

16. A method for simplifying an ungraceful shutdown recovery process and reducing a time-to-ready (TTR) value associated with an ungraceful shutdown bootup sequence in a storage device, the storage device comprises a controller to execute the method comprising:
storing data structures to recover host data and meta data after an ungraceful shutdown in a cache in the storage device and in a host memory buffer;
executing a bootup sequence after the ungraceful shutdown;
accessing the host memory buffer during the bootup sequence;
using the data structures stored in the host memory buffer to recover the host data and meta data stored in the host memory buffer prior to the ungraceful shutdown; and
applying the host data and meta data to the bootup sequence to simplify the ungraceful shutdown recovery process and reduce the TTR value associated with the ungraceful shutdown bootup sequence.

17. The method of claim 16, further comprising storing last good written pointers for open blocks which were involved in program operations at an ungraceful shutdown timeframe, wherein information for the last good written pointers have not been saved in a memory device.

18. The method of claim 16, further comprising storing a next-to-write pointer for an open super block, wherein the next-to-write pointer has not been saved in a memory device.

19. The method of claim 16, further comprising storing an in-memory data structure update to rebuild logical-to-physical mappings in the host memory buffer, wherein the in-memory data structure update includes logical block address information including a namespace identifier plus a logical block address within a namespace for open blocks in a memory device.

20. The method of claim 16, further comprising storing a memory address for the host memory buffer in a base address register and using the memory address to access the host memory buffer during configuration of the storage device after the ungraceful shutdown.
